(19) United States
(12) Patent Application Publication
(10) Pub. No.: US 2026/0371425 A1
(43) Pub. Date: Nov. 19, 2026

(54) COMMUNICATION APPARATUS AND CONTROL METHOD THEREOF, AND STORAGE MEDIUM

(71) Applicant: CANON KABUSHIKI KAISHA, Tokyo (JP)

(72) Inventor: YUKI YOSHIKAWA, Kanagawa (JP)

(21) Appl. No.: 19/658,892

(22) Filed: Apr. 27, 2026

(30) Foreign Application Priority Data
May 14, 2025 (JP) 2025-081391

(51) Int. Cl. H04W 76/15

(52) U.S. Cl. CPC H04W 76/15

(57) ABSTRACT

A communication apparatus establishes, for multi-link communication, a plurality of links with a partner apparatus serving as a connection target, the plurality of links including a first link usable for processing for connecting to the partner apparatus and a second link different from the first link, and being used in such a manner that transmission and reception are not performed simultaneously. The communication apparatus performs communication with the partner apparatus using the plurality of links. In a case where the first link is occupied by another communication apparatus different from the communication apparatus and the partner apparatus and the second link is not occupied, the communication apparatus performs, in an occupancy period during which the first link is occupied, communication in a communication mode using the second link and not using the first link.

### BACKGROUND

### FIELD OF THE TECHNOLOGY

The present disclosure relates to a communication apparatus and a control method thereof, and a storage medium.

### DESCRIPTION OF THE RELATED ART

The IEEE (Institute of Electrical and Electronics Engineers) 802.11 standards are known as communication standards relating to wireless local area networks (wireless LANs). In the IEEE 802.11be standard and the IEEE 802.11bn standard, which is a successor standard thereof, the introduction of multi-link communication is investigated in order to realize low latency communication in addition to a high peak throughput (US-2021-0211375). An access point (AP) and a station (STA) that support multi-link communication are also referred to as an AP Multi-Link Device (AP MLD) and a STA MLD, respectively.

Due to hardware constraints of communication apparatuses, studies have been conducted on multi-link communication supporting Non-Simultaneous Transmit and Receive (NSTR) that operates such that, while a transmission operation is performed using one link, a reception operation using another link is not performed. Studies have been conducted on multi-link communication that defines, as a Primary Link, one of a plurality of links to which NSTR is applied, and uses only the Primary Link for processing for connecting to a partner apparatus. A Non-Primary Link other than the Primary Link is subject to a constraint that the Non-Primary Link is used only in a case where the Primary Link is usable.

However, even if a communication apparatus uses the Non-Primary Link in an idle state while the Primary Link is used (occupied) by, for example, an overlapping BSS (OBSS), transmission and reception will not be performed simultaneously using both of the links. Therefore, by using the Non-Primary Link as much as possible during a period in which the Primary Link is occupied by another communication apparatus, it is expected that a wireless communication resource can be effectively used to realize a lower latency data communication.

### SUMMARY

The present disclosure provides a technique by which, in a communication apparatus to which NSTR is applied, a second link (Non-Primary Link) is effectively used during a period in which a first link (Primary Link) is occupied by another communication apparatus.

According to one aspect of the present disclosure, there is provided a communication apparatus compliant with the an IEEE 802.11 standards, comprising: an establishing unit configured to establish, for multi-link communication, a plurality of links with a partner apparatus serving as a connection target, the plurality of links including a first link usable for processing for connecting to the partner apparatus and a second link different from the first link, and being used in such a manner that transmission and reception are not performed simultaneously; and a communication unit configured to perform communication with the partner apparatus using the plurality of links, wherein in a case where the first link is occupied by another communication apparatus different from the communication apparatus and the partner apparatus and the second link is not occupied, in an occupancy period during which the first link is occupied, the communication unit performs communication in a communication mode using the second link and not using the first link.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 shows an example of a configuration of a wireless communication system.

FIG. 2 is a block diagram showing an example of a hardware configuration of a communication apparatus.

FIG. 3 is a block diagram showing an example of a functional configuration of the communication apparatus.

FIGS. 4A and 4B are flowcharts illustrating an example of a procedure for performing data communication between communication apparatuses.

FIG. 5 shows an example of a communication sequence in a case where an AP performs data transmission.

FIG. 6 shows an example of a communication sequence in a case where an STA performs data transmission.

FIG. 7 shows an example of a configuration of a UHR Operation element.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Configuration of Wireless Communication System

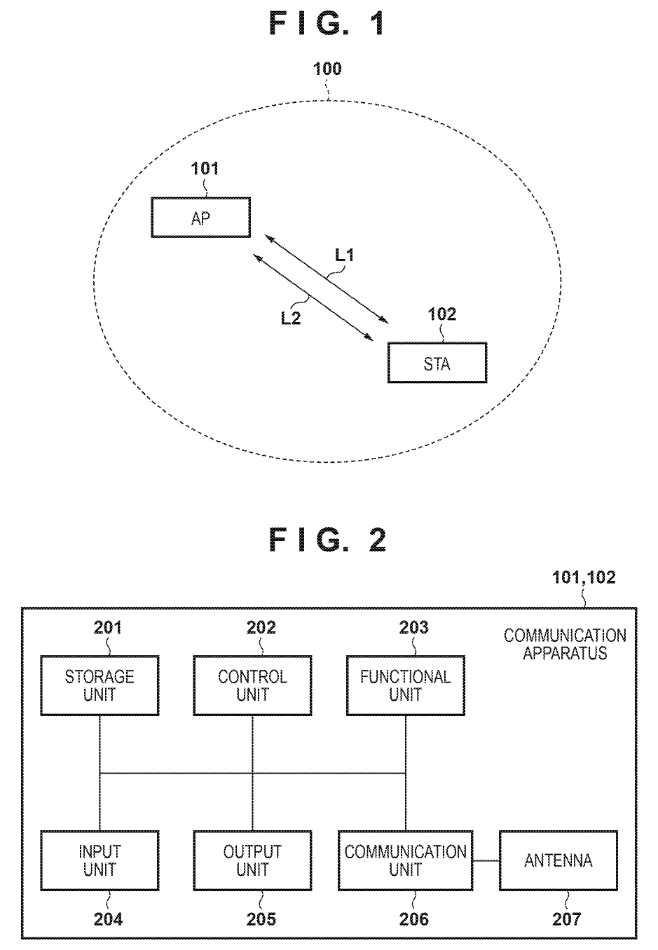

FIG. 1 shows an example of a configuration of a wireless communication system according to the present embodiment. The wireless communication system includes, for example, an access point apparatus (AP) and a station apparatus (STA) as one or more communication apparatuses. FIG. 1 shows an example in which one AP (AP 101) and one STA (STA 102) exist. The AP 101 and the STA 102 are communication apparatuses capable of executing wireless communication (wireless LAN communication) compliant with the IEEE 802.11 standard series. IEEE is an abbreviation for Institute of Electrical and Electronics Engineers.

In the example of FIG. 1, the STA 102 participates in a network 100 formed by the AP 101. The network 100 may also be referred to as a Basic Service Set (BSS). In the following, the AP 101 and the STA 102 may be collectively referred to as a communication apparatus in a case where there is no need to distinguish therebetween. For the AP 101 and the STA 102, the network 100 is a BSS to which they are connected, and this BSS will be referred to as their own BSS, or simply the BSS. Although not shown in FIG. 1, another network formed by another AP may exist in the vicinity of the network 100 formed by the AP 101, and another STA may participate in the other network. For the AP 101 and the STA 102, the other network may interfere with their own BSS, and may be referred to as an Overlapping BSS (OBSS).

Although the example of FIG. 1 shows a state in which one STA (STA 102) participates in the network 100, the present disclosure is not limited thereto. Two or more STAs may participate in the network 100. Alternatively, one STA may participate in a plurality of networks.

In the present embodiment, the communication apparatus is configured to be capable of executing a communication method compliant with the IEEE 802.11bn standard or a successor standard thereof. The IEEE 802.11bn standard is a successor standard of the IEEE 802.11be standard, and aims at a maximum transmission rate of 46.08 Giga bits per second (Gbps). As a main feature of the IEEE 802.11bn standard, a function that realizes highly reliable communication, low latency communication, an improved throughput in a case of communication traffic congestion, and so forth is scheduled to be included. A radio frame used in a communication method compliant with this standard may be referred to as Ultra High Reliability (UHR) PPDU. PPDU is an abbreviation for PLCP Protocol Data Unit, and PLCP is an abbreviation for Physical Layer Convergence Protocol. Note that the names "UHR", "IEEE 802.11bn", and the like can be changed to different names when the formulation of these standards has been completed. It should be appreciated that the present specification and the claims appended thereto are applicable to any communication apparatus that uses all the successor standards of the IEEE 802.11be. The communication apparatus may support at least one legacy standard prior to the IEEE 802.11bn standard. The legacy standards are the IEEE 802.11a/b/g/n/ac/ax/be standards, for example. The communication apparatus may support other communication standards such as Bluetooth, Bluetooth Low Energy (LE), Near Field Communication (NFC), Ultra Wide Band (UWB), ZigBee, and Multi Band OFDM Alliance (MBOA). UWB includes wireless USB, wireless 1394, WiNET, and so forth. The communication apparatus may support a communication standard such as a wired LAN that uses an Ethernet cable and/or optical fiber. The communication apparatus may support a cellular communication system such as 5G New Radio (NR) and/or Long Term Evolution (LTE) defined by the 3rd Generation Partnership Project (3GPP).

The AP 101 can be, for example, but is not limited to, a wireless LAN router or a personal computer (PC), and the like. The AP 101 may be an information processing apparatus, such as a wireless chip, capable of executing wireless communication that supports the IEEE 802.11bn standard and the like. The STA 102 can be, for example, but is not limited to, a camera, a tablet, a smartphone, a PC, a mobile phone, a video camera, a headset, and a wearable device such as smart glasses or a head mounted display (HMD). The STA 102 may be an information processing apparatus, such as a wireless chip, capable of executing wireless communication that supports the IEEE 802.11bn standard. In this case, the STA 102 may be configured to execute various types of control using a hardware circuit included inside a wireless chip. Note that a processor such as an application-specific instruction set processor (ASIP), a memory, and a hardware circuit that are included inside the wireless chip may be configured to work cooperatively to execute various types of processing.

The communication apparatus (AP 101 and STA 102) may transmit and receive a radio signal, using frequency bands such as the 2.4 GHz band, the 3.6 GHz band, the 5 GHz band, and the 6 GHz band, as well as frequency bands of millimeter wave bands such as the 45 GHz band and the 60 GHz band. The frequency bands used by the communication apparatus are not limited thereto, and may include, for example, a Sub 1 GHz band and the like. The communication apparatus may perform communication using bandwidths of 20 MHz, 40 MHz, 80 MHz, 160 MHz, 320 MHz, 540 MHz, 640 MHz, 1080 MHz, and 2160 MHz. The bandwidths used by the communication apparatus are not limited thereto, and may include, for example, 240 MHz, 4 MHz, and the like. In the IEEE 802.11 standard series, a frequency channel that uses a bandwidth of 20 MHz is defined as a basic channel in frequency bands such as the 2.4 GHz, 5 GHz, and 6 GHz bands. Also, in this standard, a plurality of available channels are defined in frequency bands such as the 2.4 GHz band, the 5 GHz band, and the 6 GHz band.

In the IEEE 802.11 standard series, the communication apparatus (AP 101 and STA 102) can use a given channel in combination with another adjacent channel. Using a given channel in combination with another adjacent channel in this manner may be referred to as channel bonding. A channel bundle formed by one channel, or two or more channels adjacent to each other may be referred to as a communication link (link). That is, one link formed by two channels with a bandwidth of 20 MHz may use a bandwidth of 40 MHz. In the IEEE 802.11be standard, a bandwidth of 320 MHz is scheduled to be defined as a maximum bandwidth available in one link. Signals transmitted using this bandwidth may be either continuous or discontinuous on a frequency axis.

The communication apparatus (AP 101 and STA 102) is a multi-link device (MLD) that has a function for executing multi-link communication in which communication is performed by establishing a plurality of links respectively using a plurality of frequency channels. An AP that performs multi-link communication is also referred to as an AP MLD, and an STA that performs multi-link communication is also referred to as a Non-AP MLD or STA MLD. In multi-link communication, a plurality of links are established and used between the AP MLD and the STA MLD.

In the example of FIG. 1, two links L1 and L2 are established in parallel between the AP 101 and the STA 102. For example, the AP 101 establishes a link via a first frequency channel in the 5 GHz band as the link L1, and establishes a link via a second frequency channel in the 5 GHz band as the link L2. This enables the AP 101 to communicate with the STA 102 via both the links L1 and L2. In this case, the AP 101 maintains the link L2 via the second frequency channel in parallel with the link L1 via the first frequency channel. In this manner, the AP 101 can improve the throughput of the communication with the STA 102 by establishing a plurality of links with the STA 102 using respective frequency channels and performing multi-link communication.

Note that a plurality of links that use different frequency bands (e.g., a link in the 5 GHz band and a link in the 6 GHz band) may be established as the plurality of links established between the communication apparatuses for multi-link communication. Alternatively, a plurality of links may be established via a plurality of different channels included in the same frequency band. For example, two links respectively using channel 7 and channel 39 in the 6 GHz band may be established.

A plurality of links in the same frequency band, and a link in a different frequency band may coexist as the plurality of links established for multi-link communication. For example, two links respectively using channel 36 and channel 149 in the 5 GHz band, and one link via channel 15 in the 6 GHz band may be established. By establishing a plurality of links via different frequency bands between the communication apparatuses in this manner, even in a case where a given frequency band is congested, it is possible to prevent a reduction in throughput and a communication delay by performing communication using a link established via another frequency band.

In the present embodiment, it is assumed that the AP 101 is a Non-Simultaneous Transmit and Receive (NSTR) AP MLD that cannot perform, due to hardware constraints, a Simultaneous Transmit and Receive (STR) operation in which transmission and reception are performed simultaneously in a plurality of communication links. For example, the AP 101 cannot receive data in the link L2 while transmitting data in the link L1, and transmit data in the link L2 while receiving data in the link L1. Although the present embodiment is described taking communication between an AP MLD and an STA MLD as an example, the present embodiment is also applicable to communication between an STA MLD and an STA MLD. In that case, it is assumed that one or both of the STA MLDs cannot perform the STR operation.

The communication apparatus (AP 101 and STA 102) of the present embodiment is configured to perform the NSTR operation. The communication apparatus establishes, with a partner apparatus, a plurality of links that are used so as not to simultaneously perform transmission and reception, and performs multi-link communication with the partner apparatus, using the plurality of established links. One of the plurality of links is defined as a Primary Link (first link). The Primary Link (first link) is used for processing for connecting to the partner apparatus. That is, the transmission and reception of a management frame is performed using only the Primary Link, and a Non-Primary Link (second link), which is a link different from the Primary Link, will not be used for the transmission and reception of a management frame. Processing for disconnecting from the partner apparatus is also performed using the Primary Link.

The communication apparatus (AP 101 and STA 102) of the present embodiment is configured to have a communication mode using the Non-Primary Link (second link) without using the Primary Link (first link) (i.e., performs communication using only the Non-Primary Link). In the present embodiment, this communication mode is also referred to as a Non-primary mode. The communication apparatus is configured to, in a case where the Primary Link (first link) is occupied by another communication apparatus different from the communication apparatus and the partner apparatus, and the Non-Primary Link (second link) is not occupied, perform communication in the Non-primary mode within an occupancy period (within a NAV period) during which the Primary Link is occupied. Accordingly, in the communication apparatus to which NSTR is applied, it is possible to effectively use the Non-Primary Link (second link) in a period during which the Primary Link (first link) is occupied by the other communication apparatus.

### Hardware Configuration of Communication Apparatus

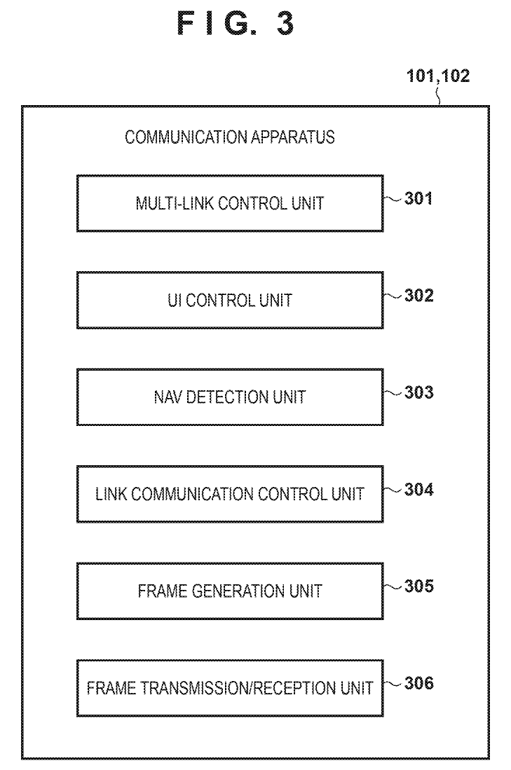

FIG. 2 is a block diagram showing an example of a hardware configuration of the communication apparatus (AP 101 and STA 102) according to the present embodiment. The communication apparatus includes, as an example of its hardware configuration, for example, a storage unit 201, a control unit 202, a functional unit 203, an input unit 204, an output unit 205, a communication unit 206, and an antenna 207. The communication apparatus may include a plurality of antennas. Note that these are merely examples, and the communication apparatus may include additional configurations that are not shown in FIG. 2, or all or part of the configurations shown in FIG. 2 may be replaced by other configurations having the same functions.

The storage unit 201 is composed of one or more memories such as a read only memory (ROM) and/or a random access memory (RAM). The storage unit 201 stores various types of information such as a computer program (group of instructions) for performing various types of operations described later, and communication parameters for wireless communication. Note that other types of storage mediums such as a flexible disk, a hard disk, an optical disk, a magneto-optical disk, a CD-ROM, a CD-R, a magnetic tape, a nonvolatile memory card, and a DVD may be used as the one or more memories constituting the storage unit 201. Also, the storage unit 201 may include a plurality of memories or the like.

The control unit 202 is composed of one or more processors such as a central processing unit (CPU) and/or a micro processing unit (MPU). The control unit 202 performs overall control of the communication apparatus by reading out the computer program (group of instructions) stored in the storage unit 201 and executing the computer program. Note that the control unit 202 may be configured to perform overall control of the apparatus by the computer program stored in the storage unit 201 and an operating system (OS) working cooperatively with each other. The control unit 202 may include a plurality of processors such as multi-core processors, and perform overall control of the apparatus using the plurality of processors.

The control unit 202 generates data or a signal (radio frame) that is to be transmitted in communication with another communication apparatus. The control unit 202 further controls the functional unit 203 to execute predetermined processing such as communication, image capturing, printing, and projection. The functional unit 203 is configured by hardware for the communication apparatus to execute the predetermined processing. In a case where the communication apparatus is a printer, the functional unit 203 is a printing device, and performs printing processing based on image data obtained via the communication unit 206, for example. In a case where the communication apparatus is a scanner, the functional unit 203 is a reading device, and outputs image data generated through scanning. In a case where the communication apparatus is a camera, the functional unit 203 includes an image sensor and a lens, and outputs image data captured by the camera. In a case where the communication apparatus is a projector, the functional unit 203 is a projection unit, and performs projection processing.

The input unit 204 accepts various types of operations from the user. The output unit 205 performs various types of outputs to the user via a monitor screen, a speaker, a Web UI, or the like. Here, outputs by the output unit 205 may be one or more of display on a monitor screen, voice output using a speaker, vibration output, and the like. The input unit 204 and the output unit 205 may be implemented as one module such as a touch panel display. The input unit 204 and the output unit 205 may each be configured as one piece with the communication apparatus, or may be provided separately from the communication apparatus.

The communication unit 206 executes control for performing wireless communication compliant with the IEEE 802.11 standard series (IEEE 802.11 standards). The communication unit 206 may control wireless communication compliant with, for example, the IEEE 802.11bn standard, and a successor standard thereof or a legacy standard prior thereto. Also, the communication unit 206 may control wired communication such as a wired LAN. The communication unit 206 controls the antenna 207 to transmit and receive signals for wireless communication generated by the control unit 202. For example, the communication apparatus transmits and receives various types of data (e.g., image data, document data, and video data) to and from a partner apparatus (another communication apparatus) via the communication unit 206.

Note that, in a case where the communication apparatus supports the NFC standards, the Bluetooth (registered trademark) standard, and the like in addition to the IEEE 802.11 standard series, the communication unit 206 may control wireless communication compliant with these communication standards. In a case where the communication apparatus is capable of executing wireless communication compliant with a plurality of communication standards, the communication apparatus may include separate communication units and antennas supporting different communication standards.

The antenna 207 is an antenna capable of detecting and emitting radio waves in, for example, the 2.4 GHz band, the 5 GHz band, and the 6 GHz band. Note that the antenna 207 may be configured to enable communication in the same frequency band. In this case, the antenna 207 may be a multi-band antenna that enables communication in a plurality of frequency bands, for example. FIG. 2 shows an example in which the communication apparatus includes only one antenna. However, a plurality of antennas corresponding to the number of usable spatial streams may be used, for example. Note that, in a case where the communication apparatus includes a plurality of antennas, the communication apparatus may include communication units 206 respectively corresponding to the antennas. The antenna 207 may be provided separately from the communication unit 206, or may be configured as one module together with the communication unit 206.

### Functional Configuration of Communication Apparatus

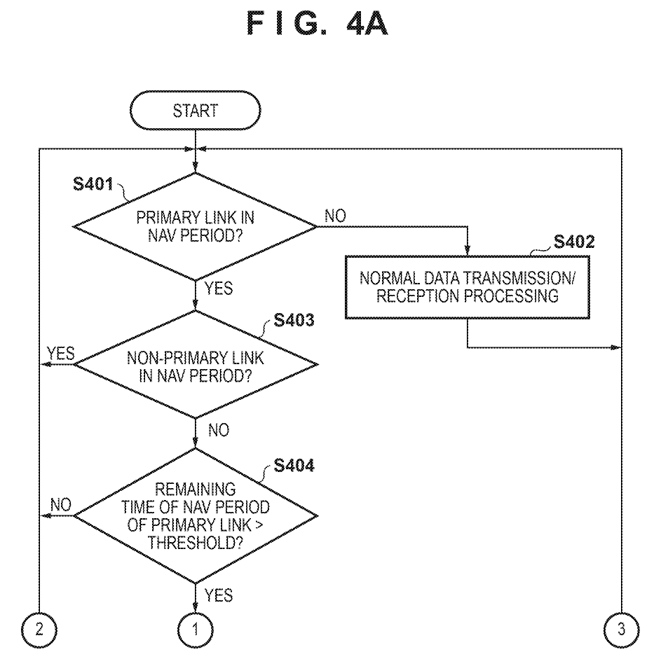

FIG. 3 is a block diagram showing an example of a functional configuration (example of a software configuration) of the communication apparatus (AP 101 and STA 102) according to the present embodiment. The communication apparatus includes, as functional units (functional blocks) thereof, for example, a multi-link control unit 301, a UI control unit 302, a NAV detection unit 303, a link communication control unit 304, a frame generation unit 305, and a frame transmission/reception unit 306.

Note that the functional configuration shown in FIG. 3 is merely an example, and other functions may be added thereto, or the illustrated functions may be modified. For example, one functional block shown in FIG. 3 may be divided into a plurality of blocks, or a plurality of functional blocks may be aggregated into one block. Also, part of the functions may be omitted, and functions that are not illustrated may be added. In one example, at least part of the functions shown in FIG. 3 may be implemented by the control unit 202 executing the program stored in the storage unit 201. Also, at least part of the functions shown in FIG. 3 may be implemented with dedicated hardware.

The multi-link control unit 301 performs control relating to multi-link communication. For example, the multi-link control unit 301 controls connection processing for establishing one or more links used for wireless communication with a connection target apparatus (partner apparatus). The multi-link control unit 301 further controls processing for adding or deleting a communication link after communication has been started, and communication termination processing for deleting all communication links. Specifically, the connection processing includes authentication processing, association processing, and 4-way-hand-shake (4WHS) processing.

The UI control unit 302 controls the input unit 204 so as to accept an input from the user via a user interface (UI) such as a touch panel or a button for accepting an operation of the communication apparatus by the user. Also, the UI control unit 302 controls the output unit 205 so as to perform an output (display of an image, voice output, or the like) for presenting information to the user. The UI control unit 302 may cause a graphical UI (GUI) to be displayed on a display, for example, and control the input unit 204 and the output unit 205 so as to accept an input from the user operating the GUI. The UI control unit 302 may further be configured to provide a GUI to an external apparatus using the communication unit 206, and accept an input from the user through the GUI displayed on the external apparatus. The UI control unit 302 may perform various types of settings in accordance with the accepted user input, and save setting data indicating the settings in the storage unit 201.

The NAV detection unit 303 performs processing for detecting an occupancy state in which the frequency channel used in each of the links established for multi-link communication is occupied by another communication apparatus (other than the partner apparatus in multi-link communication). The occupancy state by the other communication apparatus is detected as a Network Allocation Vector (NAV). For example, in a case where another communication apparatus performs data transmission by unicast communication, multi-cast communication, or broadcast communication, the frequency channel is occupied by the other communication apparatus during a series of periods relating to data transmission as periods for data transmission. A period during which a communication link for data transmission is occupied (reserved) by another communication apparatus in this manner may also be referred to as a NAV period (occupancy period). During a NAV period, basically, any communication apparatus other than a communication apparatus occupying a communication link and a communication apparatus that receives a frame transmitted by the aforementioned communication apparatus cannot perform communication in the communication link.

The NAV detection unit 303 is configured to detect a NAV in a communication link (detect that a communication link is in a NAV period), and detect the period length thereof (length of the NAV period). The NAV detection unit 303 may detect a NAV (detect an occupancy state of the communication link), for example, based on information regarding a Duration field included in a received signal, and detect the period indicated by the Duration field as the NAV period (occupancy period).

The link communication control unit 304 determines a communication link usable for data communication, based on information output from the NAV detection unit 303 and a frame received by the frame transmission/reception unit 306, and performs communication control in accordance with a result of the determination. For example, the link communication control unit 304 performs the following determinations.
In a case where neither the Primary Link nor the Non-Primary Link is in a NAV period, it is determined that both the Primary Link and the Non-Primary Link are usable for data communication.
In a case where the Primary Link is not in a NAV period, and the Non-Primary Link is in a NAV period, it is determined that only the Primary Link is usable for data communication.
In a case where the Primary Link is in a NAV period, and the Non-Primary Link is not in a NAV period, it is determined that only the Non-Primary Link is usable for data communication under a predetermined constraint.

In the present embodiment, the predetermined constraint may be a constraint that the (minimum) time required to perform data communication in the Non-Primary Link falls within a NAV period in the Primary Link. As the time required to perform data communication in the Non-Primary Link, the following time may be required.
Switching time required to switch a reference link for data transmission between the Primary Link and the Non-Primary Link.
Time required for initial frame exchange.
Time required to transmit data (at least one data frame).
Time required to transmit a response frame. ‐ Time of Short Interframe Space (SIFS) between frames.

The time required to perform data communication in the Non-Primary Link can be determined as the sum total of the above-described times. For example, in a case where the time required to perform data communication in the Non-Primary Link falls within the NAV period in the Primary Link, the link communication control unit 304 may determine that communication using only the Non-Primary Link is possible. On the other hand, in a case where the time required to perform data communication in the Non-Primary Link does not fall within the NAV period in the Primary Link, the link communication control unit 304 may determine that communication using only the Non-Primary Link is not possible.

The above-described determinations performed by the link communication control unit 304 may be executed in response to the first detection of a NAV period, or may be executed in response to obtaining a transmission opportunity (transmission right) in the Non-Primary Link after the first detection of a NAV period. For example, in a case of performing data transmission on a frequency channel that is being used in the Non-Primary Link by another communication apparatus, the link communication control unit 304 obtains the remaining time of the NAV period in the Primary Link, based on the length of the data to be transmitted. The link communication control unit 304 compares the length of the remaining time of the NAV period, and the time (the total sum of the above-described times) required to perform data communication in the Non-Primary Link, and determines, based on a result of the comparison, whether communication using only the Non-Primary Link is possible.

The frame generation unit 305 is configured to generate a frame to be transmitted. The frame generation unit 305 generates a MAC frame including a management frame and a data frame. The management frame may be, for example, a Beacon, a Probe Request, a Probe Response, an Authentication Request, an Association Request, or the like. The frame transmission/reception unit 306 transmits a radio frame including the MAC frame generated by the frame generation unit 305, and receives a radio frame from the partner apparatus (other apparatus).

### Processing Procedure

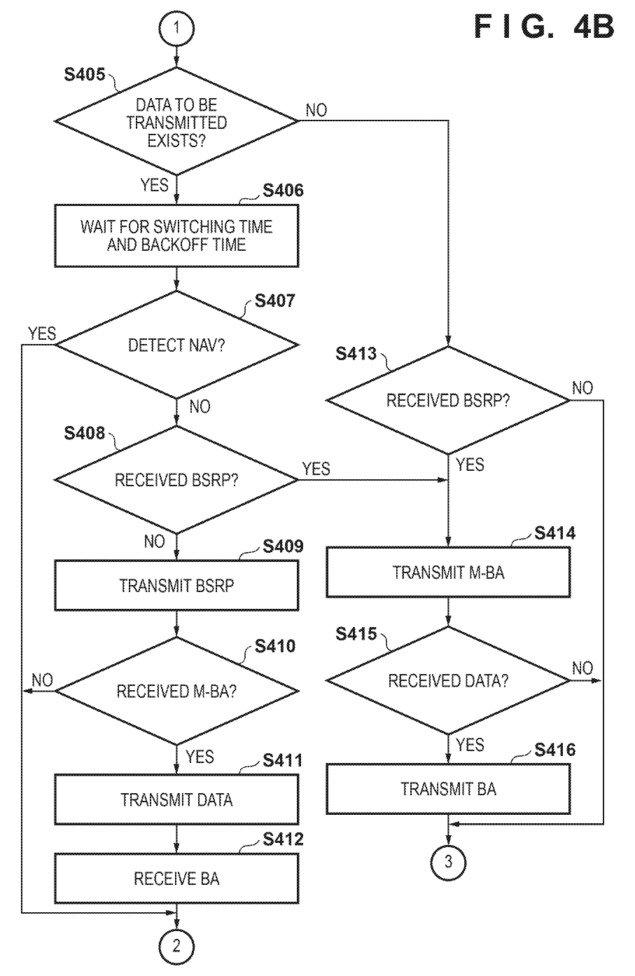

FIGS. 4A and 4B are flowcharts illustrating an example of a procedure for performing data communication between the communication apparatuses (between the AP 101 and the STA 102). The processing according to this procedure is started after the STA 102 has connected to the AP 101. In the present embodiment, the AP 101 is an NSTR AP MLD, and the connection processing between the AP 101 and the STA 102 is performed using the Primary Link. Although the following description is given for an example in which the AP 101 executes the processing according to this procedure, the same description applies to a case where the STA 102 executes the processing according to this procedure. In that case, the AP 101 may be read as the STA 102.

The processing according to this procedure may be applied only in a case where the AP 101 and the STA 102 check Capability of a partner apparatus serving as a connection target during Association performed by the AP 101 and the STA 102 when connecting to each other, and the partner apparatus supports communication using only the Non-Primary Link. The Capability is given to, for example, a UHR Capability element. The UHR Capability may be included in a management frame such as an Association Request, an Association Response, a Reassociation Request, a Reassociation Response, a Probe Request, a Probe Response, and a Beacon.

First, in S401, the AP 101 determines whether the Primary Link is in a NAV period. The AP 101 advances the processing to S402 if the Primary Link is not in a NAV period, and advances the processing to S403 if the Primary Link is in a NAV period. In S403, the AP 101 determines whether the Non-Primary Link is also in a NAV period. The AP 101 returns the processing to S401 if the Non-Primary Link is also in a NAV period. In this case, both the Primary Link and the Non-Primary Link are in a NAV period (occupied by another communication apparatus), and the AP 101 cannot use either of the links for data communication with the STA 102. Accordingly, the AP 101 repeats the determinations in S401 and S403, thereby waiting until the NAV period ends in at least one of the links.

In S402, the AP 101 performs normal data transmission/reception processing. The normal data transmission/reception processing includes, for example, transmission/reception of a data frame, transmission/reception of a control frame such as an ACK, an RTS or a CTS, and transmission/reception of a management frame including an Action frame. Upon completion of the data transmission/reception processing, the AP 101 returns the processing to S401, and repeats the above-described determinations.

If the Non-Primary Link is not in a NAV period (not occupied by another communication apparatus), the AP 101 advances the processing from S403 to S404. The processing from S404 to S416 is processing executed in a case where the Primary Link is in a NAV period (occupied by another communication apparatus) whereas the Non-Primary Link is not in a NAV period (not occupied by another communication apparatus).

In S404, the AP 101 determines whether the length of the remaining time of the NAV period of the Primary Link is greater than or equal to a threshold. The AP 101 advances the processing to S405 if the length of the remaining time is greater than or equal to the threshold, and returns the processing to S401 if the length of the remaining time is below the threshold. In accordance with this determination, it is decided whether the AP 101 operates in a communication mode (Non-primary mode) in which communication is performed using only the Non-Primary Link. The AP 101 returns the processing to S401 in a case where the AP 101 does not perform an operation in the Non-primary mode, and waits until the NAV period of the Primary Link expires. On the other hand, the AP 101 performs processing in and after S405 in a case where the AP 101 operates in the Non-primary mode.

As the above-described threshold used in S404, the minimum time required to perform communication in the Non-primary mode (the time required to complete exchange of at least one frame) is set. The minimum time required to perform communication in the Non-primary mode includes at least the following times, and the above-described threshold can be determined as the total sum of these times, for example.
Switching time required to switch a reference link for data transmission between the Primary Link and the Non-Primary Link.
Time required for initial frame exchange.
Time required to transmit data (at least one data frame).
Time required to transmit a response frame.
Time of SIFS between frames.

According to the processing from S401 to S404, for example, in a case where the NAV period of the Primary Link is long, and the NAV period of the Non-Primary Link is short, it is possible to advance the processing to S405 after expiration of the NAV period of the Non-Primary Link, and perform communication in the Non-primary mode. Specifically, the processing is advanced to S405 in a case where the NAV period of the Primary Link sufficiently remains after data transmission to the AP 101 by another STA in the Non-Primary Link has been completed within the NAV period of the Primary Link. In this manner, it is possible to perform communication control so as to be able to proceed to the processing for performing data communication in the Non-Primary Link.

In S405, the AP 101 determines whether it has data to be transmitted. The AP 101 advances the processing to S406 if it has data to be transmitted, and advances the processing to S413 if it does not have data to be transmitted. Note that this procedure may be modified such that the determination in S405 is performed prior to S401.

If the AP 101 does not have data to be transmitted, the AP 101 determines, in S413, whether there has been an exchange of the initial frame for indicating start of communication in the Non-Primary Link. Specifically, the AP 101 determines whether a Buffer Status Report Poll (BSRP) frame has been received. In the present embodiment, a BSRP frame is a type of a trigger frame for expecting (requesting) transmission of a Multi-STA Block Ack (M-BA) as a response thereto. To indicate waiting for transmission of an M-BA frame as a response frame, for example, the value of a GI And HE/EHT/UHR-LTF Type/TXS Mode sub-field in a Common Info field of the BSRP frame is set to "3". Alternatively, the value of a Trigger Type sub-field in the Common Info filed of the BSRP frame may be set to "9".

In S413, the AP 101 advances the processing to S414 if a BSRP frame has been received from the partner apparatus (STA 102), and returns the processing to S401 if a BSRP frame has not been received. Here, the processing in and after S414 will be performed if a BSRP frame has been received from the partner apparatus (STA 102) until the length of the remaining time of the NAV period in the Primary Link falls below a threshold (a determination of "NO" is made in S404). If a BSRP frame has been received, the AP 101 transmits an M-BA frame as a response frame to the BSRP frame in S414. The M-BA frame is not transmitted as an Ack frame, but is transmitted as a response to the BSRP frame requesting a response by the M-BA frame. In this case, the M-BA frame may include, for example, information such as the amount of data stored in a queue, the time required for data transmission, and the time (switching time) required to bring communication in the Non-Primary Link back to communication in the Primary Link.

After transmission of the M-BA frame, the AP 101 determines, in S415, whether data has been received, thereby waiting until data transmitted from the partner apparatus (STA 102) is received. For example, the AP 101 waits for reception of data until a predetermined wait time elapses. This wait period may be a period corresponding to the SIFS, or may he a period corresponding to the upper limit defined by an EDCA parameter used in the Non-Primary Link. Note that EDCA is an abbreviation for Enhanced Distributed Channel Access. While waiting for reception of data, the AP 101 may return the processing to S401 in a case where the remaining time of the NAV period falls below the threshold before reception of the data. Upon completion of reception of data ("YES" in S415), the AP 101 advances the processing to S416. In S416, the AP 101 transmits a Block Ack (BA) frame as a response to the reception of data from the partner apparatus (STA 102), and returns the processing to S401.

By returning the processing to S401 in a case where a frame other than the BSRP frame has been received in S413, it is possible to avoid receiving an unintended frame. That is, in a case where a frame other than the initial frame for data transmission has been received in the Non-Primary Link (second link), the AP 101 operates so as not to transmit a response frame to the received frame. For example, in a case where a Probe Request has been received, if the AP 101 transmits a Probe Response as a response, this means that the AP 101 performs an operation of transmitting and receiving a management frame in the Non-Primary Link. This operation is contrary to the operation of the NSTR AP MLD that transmits and receives a management frame using only the Primary Link. In a case where transmission/reception of a management frame using the Non-Primary Link is enabled, the AP 101 may perform the STR operation as a result of using the frequency channel of the Non-Primary Link to attempt connection processing by another STA that desires to connect to the AP 101. To avoid performing the STR operation in this manner, the AP 101 according to the present embodiment performs only reception of a BSRP frame, for which data transmission is intended, in the Non-Primary Link.

The AP 101 may determine the type of the frame received in S415, and in a case where an unintended frame has been received, the AP 101 may perform processing for discarding the received frame. Such an unintended frame includes, for example, a management frame (Beacon, Probe Request, Probe Response, Authentication, Association Request, Association Response, Reassociation Request, Reassociation Response, etc.), and a control frame other than RTS (Request to Send), CTS (Clear to Send), and Ack frames. This makes it possible to prevent the AP 101 from performing the STR operation as a result of performing connection processing or disconnection processing using the Non-Primary Link.

Note that, in the determination processing in S405, only a data frame (frame to be received in S415) may be determined as a frame to be transmitted. This makes it possible to prevent the AP 101 from performing the STR operation as a result of performing connection processing or disconnection processing using the Non-Primary Link.

If the AP 101 has the data to be transmitted ("YES" in S405), the AP 101 starts a wait for a switching time and a backoff time in S406. Specifically, the AP 101 performs backoff processing using a backoff counter defined based on the EDCA parameter, thereby waiting until the backoff time elapses. The AP 101 further waits for the longer one of its own switching time and the switching time notified from the STA 102 during connection processing between the AP 101 and the STA 102. Note that the EDCA parameter used for the Non-Primary Link may be the same as that used for the Primary Link, or a different parameter dedicated for access in the Non-Primary Link may be provided.

While the wait processing in S406 is performed, the AP 101 determines, in S407, whether a NAV (occupancy state in which the Non-Primary Link is occupied by another communication apparatus) has been detected in the Non-Primary Link. If a NAV has been detected, the AP 101 cannot perform data communication using the Non-Primary Link, and therefore returns the processing to S401. On the other hand, if a NAV has not been detected, the AP 101 advances the processing to S408. While the wait processing in S406 is performed, the AP 101 determines, in S408, whether a BSRP frame has been received from the partner apparatus (STA 102). If a BSRP frame has been received while the wait processing is performed, the AP 101 advances the processing to S414, and performs the above-described processing. If a BSRP frame has not been received from the partner apparatus (STA 102), the AP 101 advances the processing to S409.

Note that, if a frame other than the BSRP frame has been received, the AP 101 may return the processing to S401. This makes it possible to avoid receiving an unintended frame. If a multicast frame including the AP 101 as a destination, or a broadcast frame has been received, the AP 101 may advance the processing to S415.

In S409, the AP 101 transmits a BSRP frame to the partner apparatus (STA 102). This BSRP frame indicates that there will now be data transmission in the Non-Primary Link, and is a frame for starting initial frame exchange. The configuration of the BSRP frame is the same as the configuration of the BSRP frame received from the STA 102 in S413.

After transmitting the BSRP frame, the AP 101 determines, in S410, whether an M-BA frame has been received. If an M-BA frame has not been received, the AP 101 can determine that the partner apparatus (STA 102) cannot perform communication in the Non-Primary Link for some reason. For example, in a case where a NAV has not been detected in the Primary Link, or a case where a NAV has been detected in the Non-Primary Link, the partner apparatus (STA 102) cannot perform communication in the Non-Primary Link. If an M-BA frame has not been received, the AP 101 cannot perform data transmission in the Non-Primary Link. In this case, the AP 101 returns the processing to S401. Note that the configuration of the M-BA frame is the same as the configuration of the M-BA frame transmitted in S414.

Upon receiving an M-BA frame from the partner apparatus (STA 102), the AP 101 advances the processing to S411. In S411, the AP 101 starts transmission of data (data frame) to the partner apparatus after an elapse of a period corresponding to the SIFS. Upon completion of transmission of the data frame, the AP 101 waits for reception of the BA frame corresponding to the data frame in S412. In a case where the AP 101 is unable to receive the BA frame, or unable to confirm reception for a specific MPDU frame based on the received BA frame, the AP 101 may execute processing for re-transmitting the data frame. Upon confirming successful reception of the transmitted data frame by the partner apparatus based on the BA frame, the AP 101 returns the processing to S401.

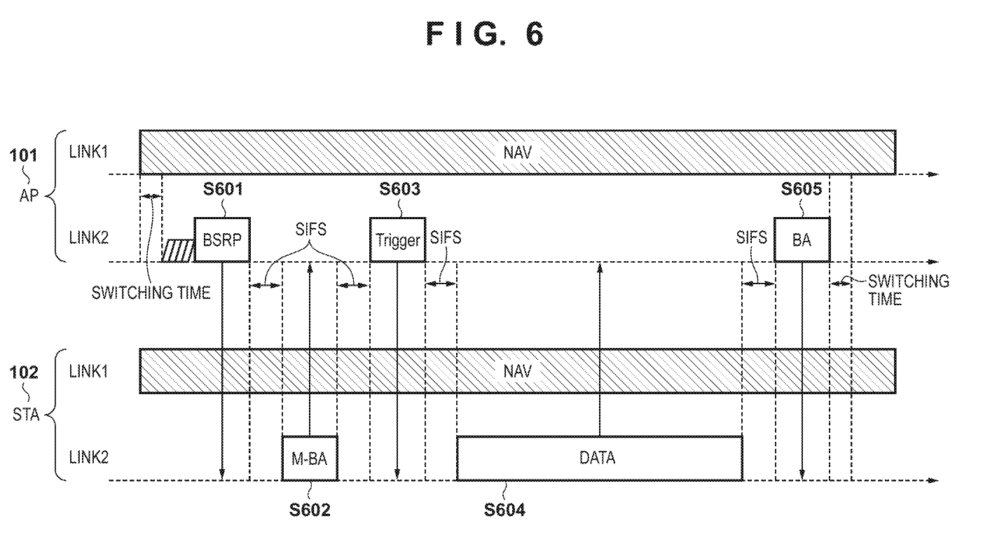

In the present embodiment, an example is described in which, of the AP 101 and the STA 102, the communication apparatus on the data transmission side transmits a BSRP frame. However, the AP 101 may always transmit a BSRP frame (as in the example of FIG. 6 described later). In that case, the AP 101 transmits a BSRP frame when starting the operation in the Non-primary mode, and receives the corresponding M-BA frame from the partner apparatus (STA 102). Based on the content of the received M-BA frame, the AP 101 transmits a trigger frame in the Non-Primary Link, thereby prompting the STA 102 to transmit data (data frame).

### Example of Communication Sequence During Data Transmission Performed by AP

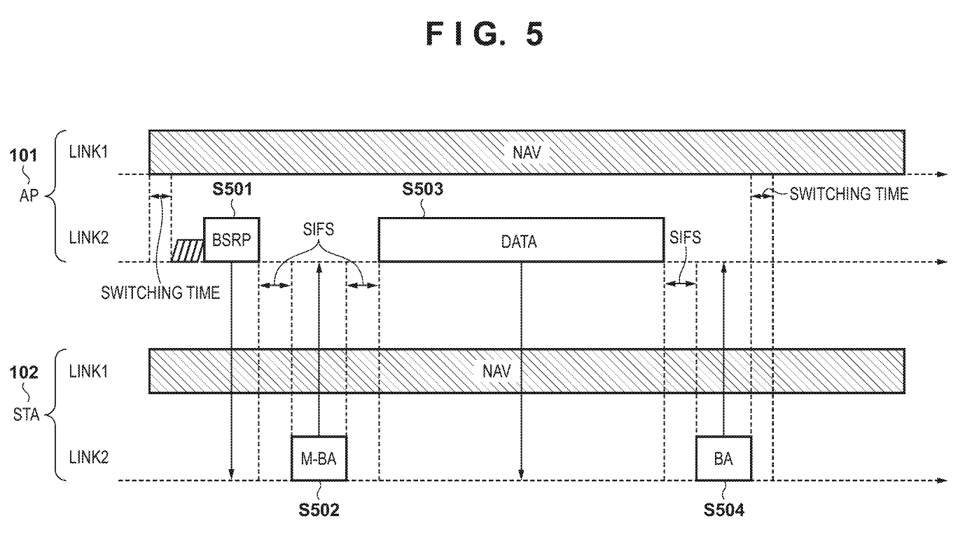

FIG. 5 shows an example of a communication sequence in a case where the AP 101 performs data transmission to the STA 102 using the Non-Primary Link. In this example, it is assumed that the link 1 is the Primary Link, and the link 2 is the Non-Primary Link. It is also assumed that although the AP 101 has a frame to be transmitted (data), the AP 101 has set a NAV in the Primary Link (link 1) as a result of detecting a frame exchange in the OBSS. Accordingly, the link 1 is in a NAV period.

Based on the processing according to the procedure of FIGS. 4A and 4B, the AP 101 confirms that the Primary Link (link 1) is in a NAV period, and that the remaining time of the NAV period is above a threshold. Accordingly, the AP 101 attempts to perform transmission in the Non-Primary Link (link 2). The AP 101 first determines, as a wait time, the longer one of its own switching time and the switching time of the STA 102, which is a partner apparatus (other apparatus) serving as a connection target, and waits until the wait time elapses. The switching time of the partner apparatus is specified at the time of connection to the partner apparatus, or during the subsequent frame exchange.

After an elapse of the switching time, the AP 101 performs, for transmission of a BSRP frame (S501), backoff processing using a backoff counter defined based on an EDCA parameter. The EDCA parameter used for the Non-Primary Link (link 2) may be the same as that used for the Primary Link (link 1), or a different parameter dedicated for access in the Non-Primary Link may be provided. In addition, a Contention Window (CW) parameter used in the backoff processing is reset after the communication is switched to communication in the Non-Primary Link.

After an elapse of the backoff time, in a case where a NAV is not set in the Non-Primary Link (link 2), and the AP 101 is not receiving a frame, the AP 101 transmits a BSRP frame to the STA 102 in the Non-Primary Link (S501). Based on receiving a BSRP frame in the Non-Primary Link (link 2), the STA 102 transmits an M-BA frame as a response to the BSRP frame in the Non-Primary Link (S502). Based on successfully receiving the M-BA frame, the AP 101 determines that preparation of data transmission has been completed, and starts data transmission in the Non-Primary Link (S503).

As an acknowledgement response for the reception of data from the AP 101, the STA 102 transmits a BA frame to AP 101 in the Non-Primary Link (link 2) (S504). Here, the reception of the BA frame is required to be completed within the NAV period in the Primary Link (link 1). Therefore, when transmitting the data to the STA 102, the AP 101 may adjust the amount of the data to be transmitted to the STA 102 such that the reception of the BA frame from the STA 102 is completed within the NAV period. The period for a transmission right (Transmission Opportunity: TXOP) ensured by the BSRP frame may be adjusted so as to fall within the NAV period in the Primary Link. In this manner, in a case where the AP 101 transmits a data frame to the partner apparatus (STA 102), the AP 101 adjusts the amount of data to be transmitted to the partner apparatus such that the reception of a response frame (BA frame) to the data frame is completed before expiration of the occupancy period (NAV period). This makes it possible to reduce the possibility that transmission and reception of a frame are performed simultaneously using the Primary Link (link 1) and the Non-Primary Link (link 2).

This enables the AP 101 to transmit data to the STA 102 using the Non-Primary Link (link 2). In the example of FIG. 5, the AP 101 transmits a BSRP frame to the STA 102 in order to perform data transmission to the STA 102. However, this operation may be reversed. That is, the STA 102 may transmit a BSRP frame to the AP 101 in order to perform data transmission to the AP 101. In these cases, the role of the AP 101 and the role of the STA 102 are reversed, but the procedure for the frame exchange is the same.

Data transmission may be performed to a plurality of STAs from the AP 101. In that case, the AP 101 may simultaneously transmit a BSRP frame and a data frame to the plurality of STAs. Each of the STAs may transmit an M-BA frame and a BA frame to the AP 101, using an RU (Resource Unit) assigned to the STA. This data frame may be a Multi User (MU) PPDU.

### Example of Communication Sequence During Data Transmission Performed by STA

FIG. 6 shows an example of a communication sequence in a case where the STA 102 performs data transmission to the AP 101 using the Non-Primary Link. In the example of FIG. 5, data transmission is performed based on the communication apparatus (AP 101 or STA 102) on the data transmission side transmitting a BSRP frame to the partner apparatus. In contrast, in this example, a case is described where the STA 102 performs data transmission based on the transmission of a BSRP frame from the AP 101 (the AP 101 prompts the STA 102 to perform data transmission). Similarly to the example of FIG. 5, it is assumed that the link 1 is the Primary Link, the link 2 is the Non-Primary Link, and the AP 101 does not have a frame to be transmitted (data).

The processing up to S602 in this example is the same as the processing up to S502 in the example of FIG. 5. The AP 101 determines from which STA a data frame should be received, based on the M-BA frame received from the STA 102 in the Non-Primary Link (link 2), and transmits a trigger frame in the Non-Primary Link based on a result of the determination (S603). With this trigger frame, RUs may be assigned to a plurality of STAs, or all RUs within the band may be assigned to one STA. The transmission of this trigger frame enables the AP 101 to prompt the STA 102 to perform data transmission.

Based on receiving the trigger frame from the AP 101, the STA 102 starts transmission of a data frame in the Non-Primary Link (link 2) (S604). Thereafter, as an acknowledgement response for the reception of data from the STA 102, the AP 101 transmits a BA frame or an M-BA frame to the STA 102 in the Non-Primary Link (S605).

In this manner, based on the AP 101 transmitting a BSRP frame in the Non-Primary Link (link 2), the STA 102 can perform data transmission in the Non-Primary Link.

### Example of UHR-Related Element

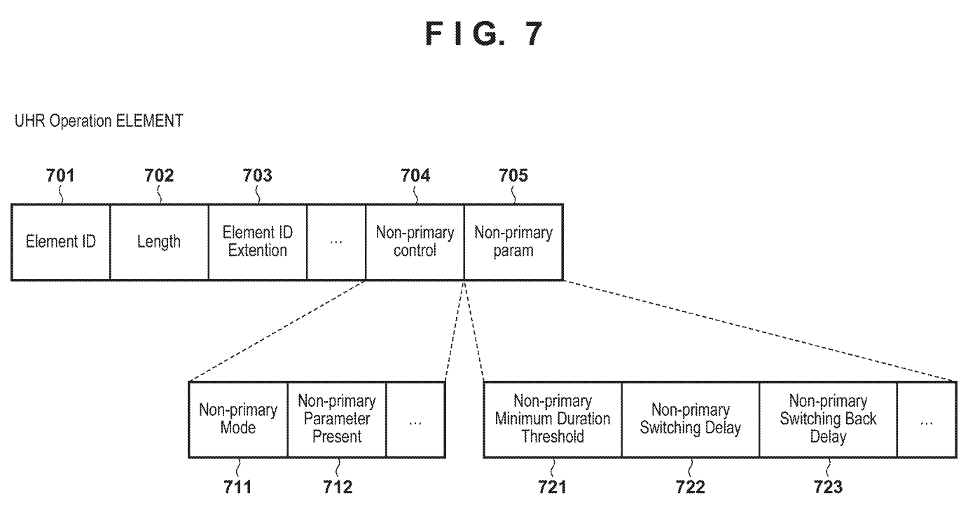

FIG. 7 shows an example of a configuration of a UHR Operation element used for notification of a parameter relating to data communication in the Non-Primary Link between the AP 101 and the STA 102. The UHR Operation element includes a parameter relating to data communication in the Non-Primary Link. The UHR Operation element may be included in, for example, any of various types of management frames such as a Beacon frame, a Probe Request frame, a Probe Response frame, an Association Request frame, an Association Response frame, a Reassociation Request frame, or a Reassociation Response frame. The UHR Operation element is stored in a management frame for transmission and reception during connection processing between the AP 101 and the STA 102 or the subsequent frame exchange. This allows each of the AP 101 and the STA 102 to obtain the switching time of the partner apparatus in addition to its own switching time.

As shown in FIG. 7, the UHR Operation element may include, for example, an Element ID field 701, a Length field 702, an Extended Element ID field 703, a Non-Primary Control field 704, and a Non-Primary param field 705.

The Element ID field 701 and the Extended Element ID field 703 indicate the type of the element including these fields. For example, in a case where "255" is stored in the Element ID field 701, and "139" is stored in the Extended Element ID field 703, this indicates that the element (target element) including these fields is the UHR Operation element. The Length field 702 indicates the length of the target element.

The Non-Primary Control field 704 is a field including a parameter for controlling communication in the Non-Primary Link. The Non-Primary Control field 704 includes, as sub-fields, for example, a Non-Primary Mode field 711 and a Non-Primary Parameter Present field 712.

The Non-primary Mode field 711 indicates whether or not a communication mode (Non-primary mode) in which communication is performed using only the Non-Primary Link is permitted. For example, the AP 101 stores "1" in this field in a case where execution of the Non-primary mode is permitted, and stores "0" in this field in a case where execution of the Non-primary mode is prohibited. The STA 102 may determine whether or not execution of the Non-primary mode is permitted (permitted or prohibited), based on, for example, the value of the Non-primary Mode field 711 included in a Beacon frame or an Association Response frame. In this manner, whether or not execution of the Non-primary mode is permitted is notified from the AP 101 to the STA 102. Note that the method for notifying whether or not execution of the Non-primary mode is permitted from the AP 101 to the STA 102 is not limited thereto. For example, the value of a field relating to communication (Non-primary mode) using only the Non-Primary Link, such as a Non-Primary Parameter Present field 712 described later, may be set to non-zero, thus indicating that access using only the Non-Primary Link is executable.

The Non-Primary Parameter Present field 712 indicates the presence or absence of the Non-primary Param field 705. For example, "1" is stored in this field in a case where the UHR Operation element includes the Non-primary Param field 705. On the other hand, "0" is stored in this field in a case where the UHR Operation element does not include the Non-primary Param field 705. The Non-primary Param field 705 includes, as sub-fields, a Non-Primary Minimum Duration Threshold field 721, a Non-Primary Switching Delay field 722, and a Non-primary Switching Back Delay field 723.

The Non-Primary Minimum Duration Threshold field 721 stores a value indicating the minimum time (as a threshold) required to perform communication using only the Non-Primary Link. In the present embodiment, the value of the Non-Primary Minimum Duration Threshold field 721 may be used for the determination processing in S404 (FIG. 4A). In the determination processing in S404, the AP 101 compares the threshold indicated by the Non-Primary Minimum Duration Threshold field 721, and the remaining time of the NAV period in the Primary Link. Based on a result of the comparison, the AP 101 may determine whether or not to execute communication using only the Non-Primary Link (communication in the Non-primary mode). The above-described threshold may be set by, for example, the AP 101, and be notified from the AP 101 to the STA 102 using the UHR Operation element.

The Non-Primary Switching Delay field 722 stores a value indicating the time (switching time) required for the AP 101 to switch the reference link for data transmission from the Primary Link to the Non-Primary Link. For example, the Non-Primary Switching Delay field 722 is composed of 6 bits. A value obtained by multiplying the value of this field by a unit time is determined as the above-described switching time. The unit time may be 4 μs (microseconds), for example.

Based on the value of the Non-Primary Switching Delay field 722 included in the frame received from the AP 101, the STA 102 obtains the switching time of the AP 101. The STA 102 may compare the obtained switching time and its own switching time, and switch the link in which carrier sense is performed, in accordance with the longer switching time. For example, in a case where the STA 102 has detected that the Primary Link is in a busy state (a NAV is set in the Primary Link), the STA 102 may start carrier sense in the Non-Primary Link after an elapse of this switching time.

The Non-primary Switching Back Delay field 723 stores a value indicating the time (switching time) required for the AP 101 to bring the used link from the Non-Primary Link back to the Primary Link after communication in the Non-Primary Link ends. For example, the Non-primary Switching Back Delay field 723 is composed of 6 bits. A value obtained by multiplying the value of this field by a unit time is determined as the above-described switching time. The unit time may be 4 μs, for example.

The STA 102 may obtain the above-described switching times based on the UHR Operation element in an A-Control field within an HT Control frame included in a frame exchanged during connection to the partner apparatus, an Action frame that is exchanged thereafter, or a data frame. The obtained switching times may be used in the determination processing in S404 (FIG. 4A).

For example, the STA 102 specifies the longer one of its own switching time and the switching time of the AP 101 for the switching time for switching from the Primary Mode to the Non-primary mode. The STA 102 specifies the longer one of its own switching time and the switching time of the AP 101 also for the switching time for switching from the Non-primary mode to the Primary Mode. The STA 102 may define, as a threshold used in S404, the total sum of the specified switching times, the time required to transmit a BSRP, an M-BA, and a BA, and the time of the SIFS between frames. Furthermore, the STA 102 may determine whether the remaining time of the NAV period in the Primary Link is greater than or equal to the threshold.

The apparatus (AP 101 or STA 102) that performs data transmission in the Non-Primary Link may adjust the amount of data to be transmitted, taking into account the longer one of the switching time of the partner apparatus and its own switching time. The switching time of the partner apparatus may be obtained based on the value of the Non-primary Switching Back Delay field 723 included in the UHR Operation element within the frame exchanged with the partner apparatus.

Alternatively, in a case where the AP 101 prompts data transmission from the STA 102 using a trigger frame as in the example of FIG. 6, the transmission period reserved by the trigger frame may be set so as to fall within the NAV period in the Primary Link. That is, in a case where the AP 101 transmits, to the partner apparatus (STA 102), a trigger frame for causing the partner apparatus to transmit a data frame, the AP 101 sets the transmission period reserved by the trigger frame so as to fall within the occupancy period (the NAV period). In this case, the transmission period reserved by the trigger frame may be set taking into account the longer one of the switching time of the AP 101 and the switching time of the partner apparatus. The switching time of the partner apparatus may be obtained based on the value of the Non-primary Switching Back Delay field 723 included in the UHR Operation element within the frame exchanged with the partner apparatus.

Note that both the Non-Primary Control field 704 and the Non-Primary param field 705, or part of the sub-fields included therein may be included in a MAC frame header, or may be separately transmitted and received as an Action frame. This enables switching of the modes and modification of the thresholds to be performed more flexibly.

As has been described thus far, the communication apparatus according to the present embodiment establishes, for multi-link communication, a plurality of links with a partner apparatus serving as a connection target, the plurality of links including a first link (Primary link) usable for processing for connecting to the partner apparatus and a second link (Non-Primary Link) different from the first link, and being used in order not to perform transmission and reception simultaneously. The communication apparatus performs communication with the partner apparatus using the plurality of links. In a case where the first link is occupied by another communication apparatus different from the communication apparatus and the partner apparatus, and the second link is not occupied, the communication apparatus performs, within the occupancy period (NAV period) during which the first link is occupied, communication in a communication mode (Non-primary mode) using the second link without using the first link.

The communication apparatus may be configured to perform communication in the Non-primary mode only in a case where, for example, the time required to perform communication in the Non-primary mode falls within the occupancy period (NAV period). More specifically, the communication apparatus may be configured to perform communication in the Non-primary mode in a case where the length of the remaining time of the occupancy period (NAV period) is greater than or equal to a threshold. The threshold may indicate the time required to perform communication in the Non-primary mode.

According to the present embodiment, during a period in which the first link (Primary link) is occupied by another communication apparatus in a communication apparatus to which NSTR is applied, it is possible to effectively use the second link (Non-Primary Link). Thus, even in a case where the first link cannot be used, it is possible to realize lower latency data communication by performing data communication using the second link.

Thus, according to the present disclosure, during a period in which the first link (Primary Link) is occupied by another communication apparatus in a communication apparatus to which NSTR is applied, it is possible to effectively use the second link (Non-Primary Link).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-081391, filed May 14, 2025, which is hereby incorporated by reference herein in its entirety.

What is claimed is:

1. A communication apparatus compliant with an IEEE 802.11 standard, comprising:
an establishing unit configured to establish, for multi-link communication, a plurality of links with a partner apparatus serving as a connection target, the plurality of links including a first link usable for processing for connecting to the partner apparatus and a second link different from the first link, and being used in such a manner that transmission and reception are not performed simultaneously; and
a communication unit configured to perform communication with the partner apparatus using the plurality of links,
wherein in a case where the first link is occupied by another communication apparatus different from the communication apparatus and the partner apparatus and the second link is not occupied, in an occupancy period during which the first link is occupied, the communication unit performs communication in a communication mode using the second link and not using the first link.

2. The communication apparatus according to claim 1, wherein
the communication unit performs communication in the communication mode only in a case where a time required to perform communication in the communication mode falls within the occupancy period.

3. The communication apparatus according to claim 1, wherein
the communication unit performs communication in the communication mode in a case where a length of a remaining time of the occupancy period is greater than or equal to a threshold.

4. The communication apparatus according to claim 3, wherein
the communication unit operates in such a manner as to not perform communication in the communication mode in a case where the length of the remaining time of the occupancy period is below the threshold.

5. The communication apparatus according to claim 3, wherein
the threshold indicates a time required to perform communication in the communication mode.

6. The communication apparatus according to claim 3, wherein
the threshold is set based on a switching time for switching a reference link for data communication between the first link and the second link, a time required for exchange of an initial frame for starting data communication, a time required for transmission of data, and a time of a Short Interframe Space (SIFS) between transmitted frames.

7. The communication apparatus according to claim 3, wherein
the threshold is stored in an Ultra High Reliability (UHR) Operation element, and is notified from the partner apparatus using a management frame that includes the UHR Operation element.

8. The communication apparatus according to claim 1, wherein
the communication unit performs communication in the communication mode, using, for the second link, an Enhanced Distributed Channel Access (EDCA) parameter used in the first link.

9. The communication apparatus according to claim 1, wherein
in a case where the communication unit transmits a data frame to the partner apparatus, the communication unit adjusts an amount of data to be transmitted to the partner apparatus such that reception of a response frame for the data frame is completed before expiration of the occupancy period.

10. The communication apparatus according to claim 1, wherein
in a case where the communication unit transmits, to the partner apparatus, a trigger frame for causing the partner apparatus to transmit a data frame, the communication unit sets a transmission period secured by the trigger frame so as to fall within the occupancy period.

11. The communication apparatus according to claim 1, wherein
wherein in a case where the communication unit has received a frame other than an initial frame for data transmission on the second link, the communication unit operates in such a manner as to not transmit a response frame for the received frame.

12. A control method for a communication apparatus compliant with the an IEEE 802.11 standards, the control method comprising:
establishing, for multi-link communication, a plurality of links with a partner apparatus serving as a connection target, the plurality of links including a first link usable for processing for connecting to the partner apparatus and a second link different from the first link, and being used in such a manner that transmission and reception are not performed simultaneously; and
performing communication with the partner apparatus using the plurality of links,
wherein in a case where the first link is occupied by another communication apparatus different from the communication apparatus and the partner apparatus and the second link is not occupied, communication in a communication mode using the second link and not using the first link is performed in an occupancy period during which the first link is occupied.

13. A non-transitory computer-readable storage medium storing a program for causing a computer to execute a control method for a communication apparatus compliant with an IEEE 802.11 standard, the control method comprising:
establishing, for multi-link communication, a plurality of links with a partner apparatus serving as a connection target, the plurality of links including a first link usable for processing for connecting to the partner apparatus and a second link different from the first link, and being used in such a manner that transmission and reception are not performed simultaneously; and
performing communication with the partner apparatus using the plurality of links,
wherein in a case where the first link is occupied by another communication apparatus different from the communication apparatus and the partner apparatus and the second link is not occupied, communication in a communication mode using the second link and not using the first link is performed in an occupancy period during which the first link is occupied.
